(19) United States
(12) Patent Application Publication
(10) Pub. No.: US 2005/0054220 A1
(43) Pub. Date: Mar. 10, 2005

(54) Electronic card enclosure

(76) Inventors: Ming Ge, Kunsan (CN); Guohua Zhang, Kunsan (CN); Zigiang Zhu, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/938,352

(22) Filed: Sep. 9, 2004

(30) Foreign Application Priority Data
Sep. 9, 2003 (CN) 03278521.6

(51) Int. Cl. H01R 13/62

(52) U.S. Cl. 439/76.1

(57) ABSTRACT

An electronic card enclosure includes a frame (1), a first shell half (2), a second shell half (3) and a shield cover (4). The frame (1) is integrally formed as a rectangular member having a rear border (14), two side arms (12) and a front border (11). The shell half (2, 3) and the shield cover (4) are rectangular-shaped. In assembly, a pair of second rim edges (33) of the second shell half (3) secures a pair of first rim edges (22) of the first shell half (2) through accommodating the two side arms (12) of the frame (1) therewithin.

### BACKGROUND OF THE INVENTION

1. Field of the Invention

The present invention relates to an electronic card enclosure, which has good shield effect as well as dependable intensity and which is easily assembled with high efficiency under a low fabrication cost.

2. Description of Related Art

Electronic cards are widely used in a digital camera or an MP3 device or a PDA device, or used as PCMCIA cards for portable computers. Because the circuit of an electronic card is complex, easily damaged and used for transferring high-speed data, it is necessary to design a kit with dependable intensity and good shield effect in order to protect internal circuit and signal transmission.

A conventional electronic card disclosed in the U.S. Pat. No. 6,341,729 generally has a rectangular frame, an electrical circuit board inserted in the frame, a first shell half securely attached on a front side of the frame and a second shell half securely attached on a rear side of the frame. Front side and rear side surfaces of the frame are respectively defined with grooves corresponding to rim edges of the first shell half and the second shell half. The rim edges of the first shell half and the second shell half are respectively fitted in the corresponding grooves defined in the frame and secured in the grooves by ultrasonic bonding or thermoplastic adhesion or laser welding etc.

However the above described conventional electronic card has certain deficiencies. At first, as disclosed in the background section of the U.S. Pat. No. 6,341,729, to assemble a finished electronic card, the thermoplastic adhesion process takes about 12 seconds, the ultrasonic bonding process takes about 3 to 4 seconds, and the laser welding process takes about 22 seconds, so the production efficiency of assembly of the electronic cards is low. Then, as additional special equipment is required by either the ultrasonic bonding process or the laser welding process in the fabrication of the electronic cards, the investment in the production must be high, so the production cost of the electronic cards is also high.

Therefore, it is desirable to have an improved electronic card enclosure to mitigate and/or obviate the aforementioned problems.

### SUMMERY OF THE INVENTION

The objection of the present invention is to provide an electronic card enclosure with good shield effect and dependable intensity, which is easily assembled with high efficiency under a low fabrication cost.

In order to achieve the objection set forth, an electronic card enclosure in accordance with the present invention comprises a frame, a first shell half, a second shell half and a shield cover. The frame is integrally formed as a rectangular member having a rear border, two side arms and a front border. The shell half and the shield cover are rectangular-shaped. In assembly, a pair of second rim edges of the second shell half secures a pair of first rim edges of the first shell half through accommodating the two side arms of the frame therewithin.

The detailed features of the present invention will be apparent in the detailed description with appropriate reference to the accompanying drawings.

### BRIEF DESCRIPTION OF THE DRAWINGS

FIG. 1 is an exploded perspective view of an electronic card enclosure in accordance with the present invention;

FIG. 2 and FIG. 3 are perspective views illustrating the assembling process of the electronic card enclosure of FIG. 1;

FIG. 4 is an assembled perspective view of the electronic card enclosure of FIG. 1; and

FIG. 5 is an enlarged cross-sectional view of a part taken from line 5-5 of FIG. 4.

### DETAILED DESCRIPTION OF THE INVENTION

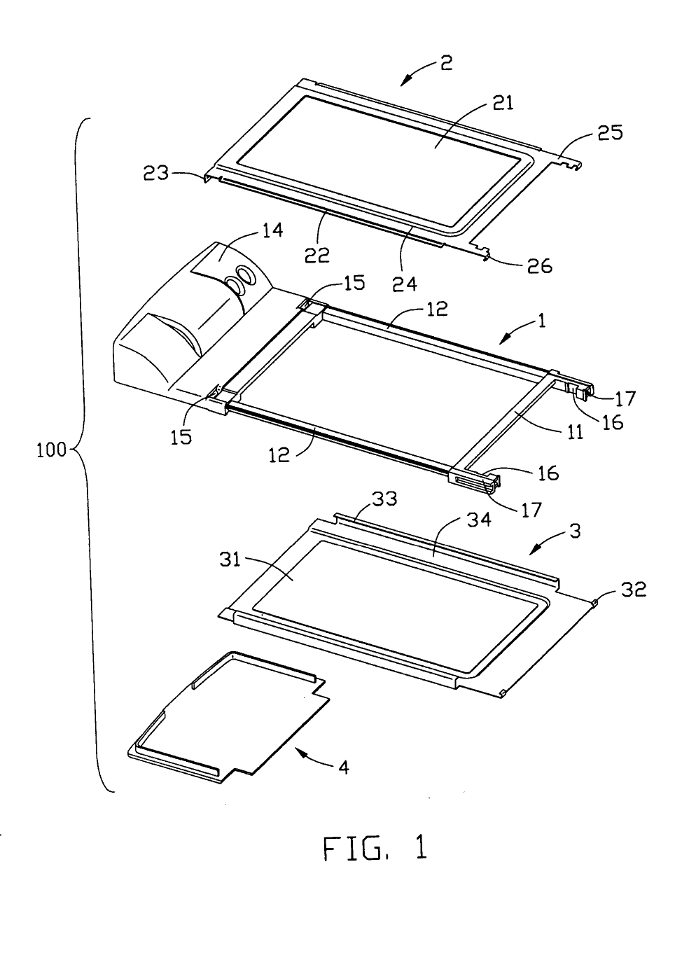

Referring to FIG. 1, an electronic card enclosure 100 comprises a frame 1, a first shell half 2, a second shell half 3 and a shield cover 4.

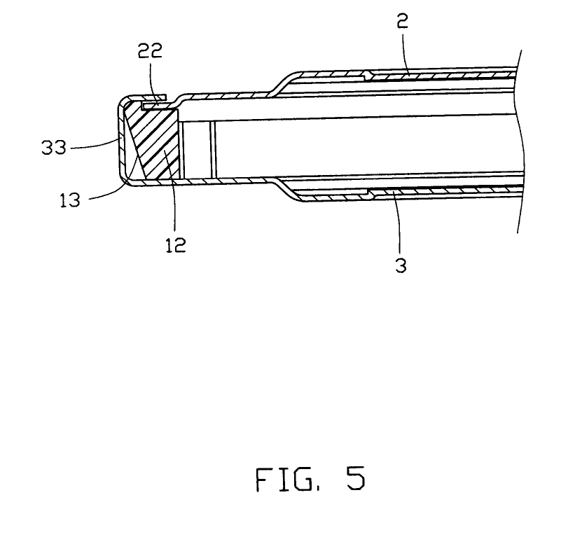

The frame 1 is integrally formed as a rectangular member having a rear border 14, which is a shape of arc and used for receiving electrical connectors connected with the present electronic card therewithin, two side arms 12, and a front border 11. Two grooves 15 are respectively formed in junctions between the rear border 14 and the two side arms 12. The side arm 12 of the frame 1 has a slant surface 13 (referring to FIG. 5). Each one of the side arms 12 has an extension 17 protruded from an end of the front border 11. The extension 17 is defined with a socket 16 in an inner side surface thereof.

The first shell half 2 is made of metal and rectangular-shaped. A rectangular center 21 is appreciably extending upwardly from the first shell half 2 so as to receive the present electronic card therewithin. Two blades 23 are extending downwardly from a transverse side of the first shell half 2. A pair of first rim edges 22 of step-shape is extending downwardly from two opposite longitudinal sides 24 of the first shell half 2. Each one of the longitudinal sides 24 has a fringe 25 protruded from an end thereof. In addition, a tab 26 is defined at an end of the fringe 25 corresponding to the socket 16 of the frame 1 and a lock 32 of the second shell half 3.

The second shell half 3 is also made of metal and rectangular-shaped. The second shell half 3 includes a rectangular center 31 appreciably extending downwardly from the rear cover 3 accordantly to receive the present electronic card therewithin, a pair of second rim edges 33 extending upwardly from two opposite longitudinal sides 34 of the second shell half 3, and two locks 32, which respectively match the two sockets 16 of the front border 11.

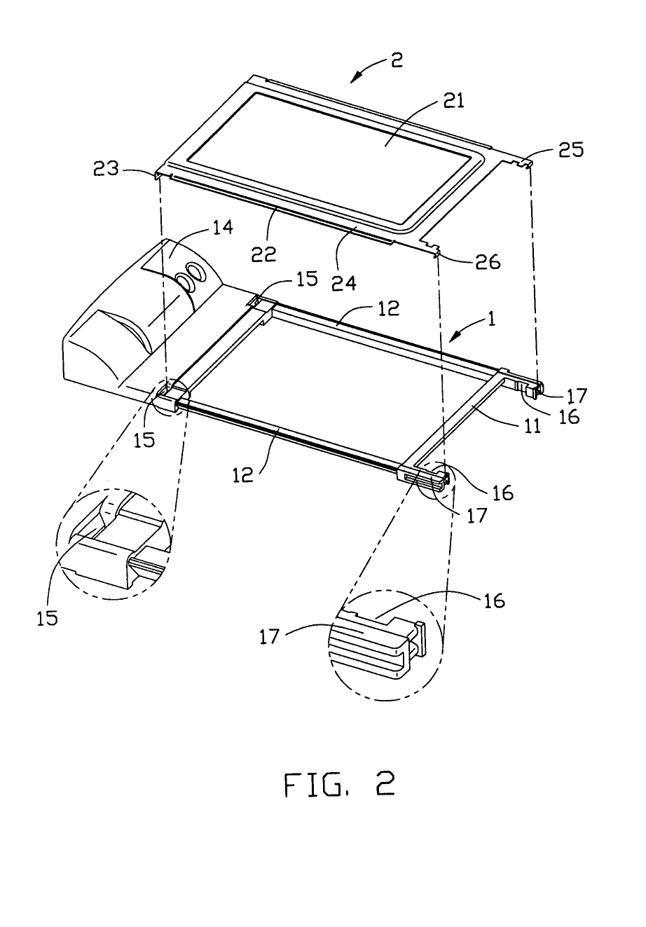

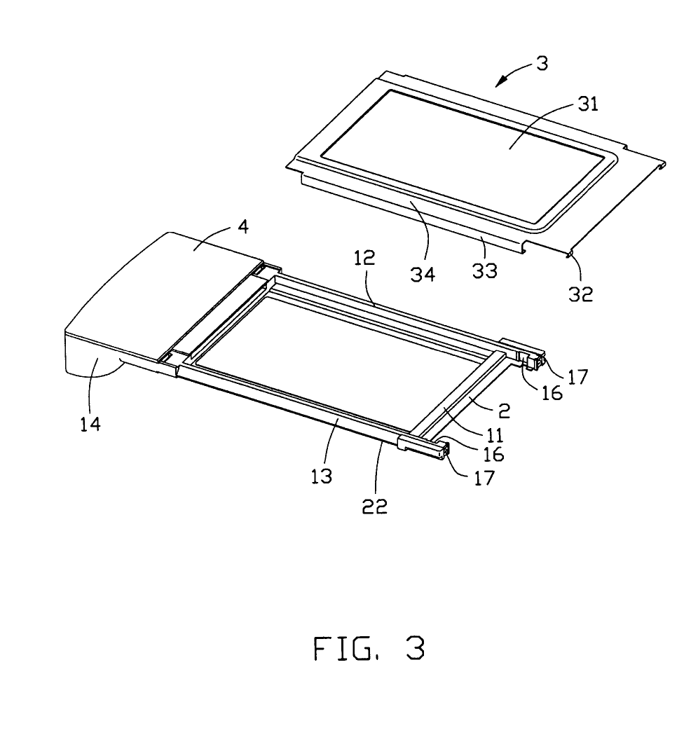

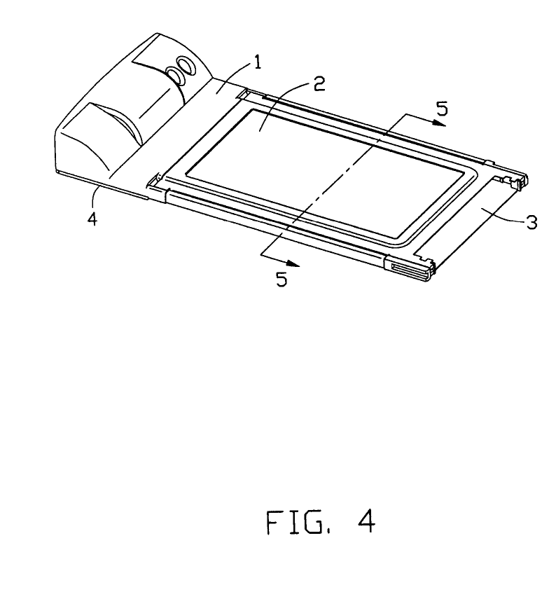

Referring to FIG. 2-5, in assembly, the first shell half 2 is first assembled onto the upper surface of the frame 1 with each blade 23 fitted into the two grooves 15, and each tab 26 secured into the two sockets 16. Then, the second shell half 3 is assembled onto the lower surface of the frame 1 with each lock 32 secured into the two sockets 16, and the pair of second rim edges 33 from downside to upside along the slant 13 pressed and secured into the pair of first rim edges 22 of the first shell half 2 through accommodating the two side arms 12 of the frame 1 therewithin. Finally, the shield cover 4 is assembled onto the rear border 14 of the frame 1.

In a second embodiment of the present invention, the first shell half 2 is assembled onto the lower surface of the frame 1 and the second shell half 3 is assembled onto the upper surface of the frame 1. Otherwise, the position of the slant surface 13 of the side arm 12 of the frame 1 is need to be adjusted correspondingly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electronic card enclosure, comprising:
a frame having two side arms;
a first shell half having a pair of first rim edges at two opposite longitudinal sides thereof; and
a second shell half having a pair of second rim edges extending upwardly from two opposite longitudinal sides thereof, each of the second rim edges having a section overlapping with a corresponding one of the first rim edges, passageways being defined between the first and second rim edges and accommodating the side arms.

2. An electronic card enclosure as claimed in claim 1, wherein the side arm of the frame has a slant surface.

3. An electronic card enclosure as claimed in claim 1, wherein the pair of first rim edges of the first shell half is step-shaped.

4. An electronic card enclosure as claimed in claim 1, wherein said frame includes a rear border, a front border, and two extensions protruded from ends of the front border.

5. An electronic card enclosure as claimed in claim 4, wherein two sockets are respectively defined in two inner side surfaces of the two extensions.

6. An electronic card enclosure as claimed in claim 5, wherein said two opposite longitudinal sides of the first shell half have two fringes protruded from the ends thereof and two tabs, which are defined at the two ends of the fringes and, when assembly, are respectively secured into the two sockets of the frame.

7. An electronic card enclosure as claimed in claim 5, wherein two locks, which are defined on the second shell half, in assembly, are respectively locked into the two sockets of the frame.

8. An electronic card enclosure as claimed in claim 1, wherein two grooves are respectively formed in junctions between the rear border and the two side arms.

9. An electronic card enclosure as claimed in claim 1, wherein two blades are extending downwardly from a transverse side of the first shell half.

10. An electronic card enclosure as claimed in claim 1, wherein two rectangular centers are respectively extending upwardly and downwardly from the first shell half and the second shell half.

11. An electronic card enclosure comprising:
a frame having two side arms;
a first shell half having a pair of first rim edges extending downwardly from two opposite longitudinal side edges thereof;
a second shell half having a pair of second rim edges respectively overlapping with the pair of first rim edges of the first shell half, the pair of second rim edges accommodating the two side arms of the frame between the first and second rim edges;
a shield cover assembled onto the rear border.

12. An electronic card enclosure as claimed in claim 11, wherein the first shell half is assembled onto the upper surface of the frame, and the second shell half is assembled onto the lower surface of the frame.

13. An electronic card enclosure as claimed in claim 12, wherein the pair of second rim edges is pressed and secured into the pair of first rim edges of the first shell half from downside to upside along the slant.

14. An electronic card enclosure as claimed in claim 11, wherein the first shell half is assembled onto the lower surface of the frame, while the second shell half is assembled onto the upper surface of the frame.

15. An electronic card enclosure as claimed in claim 14, wherein the position of the slant of the two side arms of the frame is correspondingly adjusted.

16. An electronic card enclosure comprising:
a frame having two side arms, each of said side arms defining a recessed area extending along a longitudinal direction thereof;
a first half shell essentially covering one main face of the frame and defining a pair of first rim edges received in the corresponding recessed areas, respectively; and
a second half shell essentially covering an opposite main face of the frame and defining a pair of second rim edges cooperating with the frame to sandwich said pair of first rim edges therebetween, respectively.

17. The electronic card enclosure as claimed in claim 16, wherein said second rim edge essentially defines a U-shaped cross-sectional configuration enclosing both upper and lower sides and an outer lateral side of the corresponding side arm.

18. The electrical card enclosure as claimed in claim 16, wherein said first rim edge is parallel to the main face of the frame.
